(19) United States
(12) Patent Application Publication
(10) Pub. No.: US 2025/0282656 A1
(43) Pub. Date: Sep. 11, 2025

(54) PIEZOELECTRIC SYSTEM AND METHOD FOR PER- AND POLY-FLUOROALKYL SUBSTANCE DEGRADATION

(71) Applicant: Kureha America, Inc., Houston, TX (US)

(72) Inventors: Koji Yamakawa, Houston, TX (US); Masako Akiyama, Houston, TX (US); Shunsuke Abe, Houston, TX (US)

(73) Assignee: Kureha America, Inc., Houston, TX (US)

(21) Appl. No.: 19/070,864

(22) Filed: Mar. 5, 2025

Related U.S. Application Data
(60) Provisional application No. 63/561,522, filed on Mar. 5, 2024.

(51) Int. Cl. C02F 1/467; B01J 31/06; B01J 31/26; B01J 35/33; B01J 35/39; B01J 35/58; C02F 1/32; C02F 1/36; C02F 1/70; C02F 1/72; C02F 101/36

(52) U.S. Cl. CPC C02F 1/4672; B01J 31/06; B01J 31/26; B01J 35/33; B01J 35/39; B01J 35/58; C02F 1/325; C02F 1/36; C02F 1/4676; C02F 1/70; C02F 1/725; C02F 2101/36; C02F 2305/10

(57) ABSTRACT

A system for per- and poly-fluoroalkyl substance degradation includes an outer housing and a porous article, which includes a piezoelectric material. The porous article has a porosity in a range from 40% to 90% and a piezoelectric constant d31 in a range from 5 pC/N to 150 pC/N.

### BACKGROUND

The awareness of the potential environmental impact by per- and poly-fluoroalkyl substances (PFAS) is rising globally. There are more than 15,000 compounds classified as PFAS. PFAS are made of strong carbon and fluorine (C—F) bonds, making them extremely difficult to destroy and remediate. This is the reason why PFAS are called “forever chemicals.” Specifically, contamination by PFAS in drinking water has become a certain risk for human health and the remediation process is eagerly required.

In recent years, PFAS degradation technologies have been being developed utilizing photo chemical reaction, sonolysis, hydrothermal alkaline treatment (HALT), and electrochemical oxidation. However, none of these technologies are commercially available due to low efficacy at low concentrations well as poor throughput performance. Thus, there exists a need for a technology that has improved efficacy for PFAS degradation at low concentrations as well as improved throughput performance.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for per- and poly-fluoroalkyl substance degradation including an outer housing and a porous article, where the porous article includes a piezoelectric material. The porous article has a porosity in a range from 40% to 90% and a piezoelectric constant d31 in a range from 5 pC/N to 150 pC/N.

Other aspects and advantages of the claimed subject matter will be apparent from the following description and the appended claims.

### BRIEF DESCRIPTION OF DRAWINGS

FIGS. 1A-1C are systems for per- and poly-fluoroalkyl substance degradation according to one or more embodiments.

FIG. 2 is a system including a piezoelectric fiber for per- and poly-fluoroalkyl substance degradation according to one or more embodiments.

FIG. 3 is a system including a piezoelectric bead for per- and poly-fluoroalkyl substance degradation according to one or more embodiments.

FIGS. 4A-4D are systems including a piezoelectric film for per- and poly-fluoroalkyl substance degradation according to one or more embodiments.

FIGS. 5A and 5B are systems including a piezoelectric sponge for per- and poly-fluoroalkyl substance degradation according to one or more embodiments.

FIG. 6 is a system including a piezoelectric bead for per- and poly-fluoroalkyl substance degradation according to one or more embodiments.

FIG. 7 is a system including a piezoelectric bead for per- and poly-fluoroalkyl substance degradation according to one or more embodiments.

FIG. 8 is a flowchart of a method for per- and poly-fluoroalkyl substance degradation according to one or more embodiments.

### DETAILED DESCRIPTION

In one aspect, embodiments disclosed herein relate to a system and method for per- and poly-fluoroalkyl substance (PFAS) degradation. PFAS include carbon-fluorine (C—F) bonds. C—F bonds are very challenging to break due to the strength of the bond. Thus, PFAS are generally referred to as “forever chemicals” because they remain in water supplies, soil and other environments indefinitely. Embodiments disclosed herein are directed to a system and method for PFAS degradation that include piezoelectric materials that initiate the reactions for degrading the PFAS. The piezoelectric materials may have a porosity ranging from 40% to 90%. The piezoelectric materials may have a piezoelectric constant d31 ranging from 5 picocoulombs per Newton (pC/N) to 150 pC/N.

Piezoelectric materials produce an electric charge in response to deformation. The potential amount of electric charge is represented by the piezoelectric effect constant. The piezoelectric effect constant is measured by direction of polarization and direction of applied stress or induced strain. In one or more embodiments of the present disclosure, the piezoelectric effect constant is measured by d31. d31 correlates to an induced polarization in direction 3 (along the z-axis) per unit of stress applied in direction 1 (along the x-axis). The piezoelectric effect constant may be measured by a piezoelectric coefficient device, such as a Rheolograph Solid (K. K. Toyo Seiki Seisakusho). Parameters for measuring the piezoelectric constant d31 may include a tension of 1 Newton, a frequency of 10 Hertz, and a temperature increasing from 25° C. to 150° C. at a rate of 2° C. per minute.

### System for PFAS Degradation

Embodiments disclosed herein are related to a system for PFAS degradation. The system includes an outer housing, a porous article including a piezoelectric material, and a piezoelectric effect initiator. The porous article including the piezoelectric material may produce an electric charge when deformed. The system may also include a UV-visible irradiation source, a plasma torch, a heat source, a vacuum pump, or a combination of these devices. In one or more embodiments, the porous article has a porosity ranging from 40% to 90% and a piezoelectric effect constant d31 ranging from 5 pC/N to 150 pC/N.

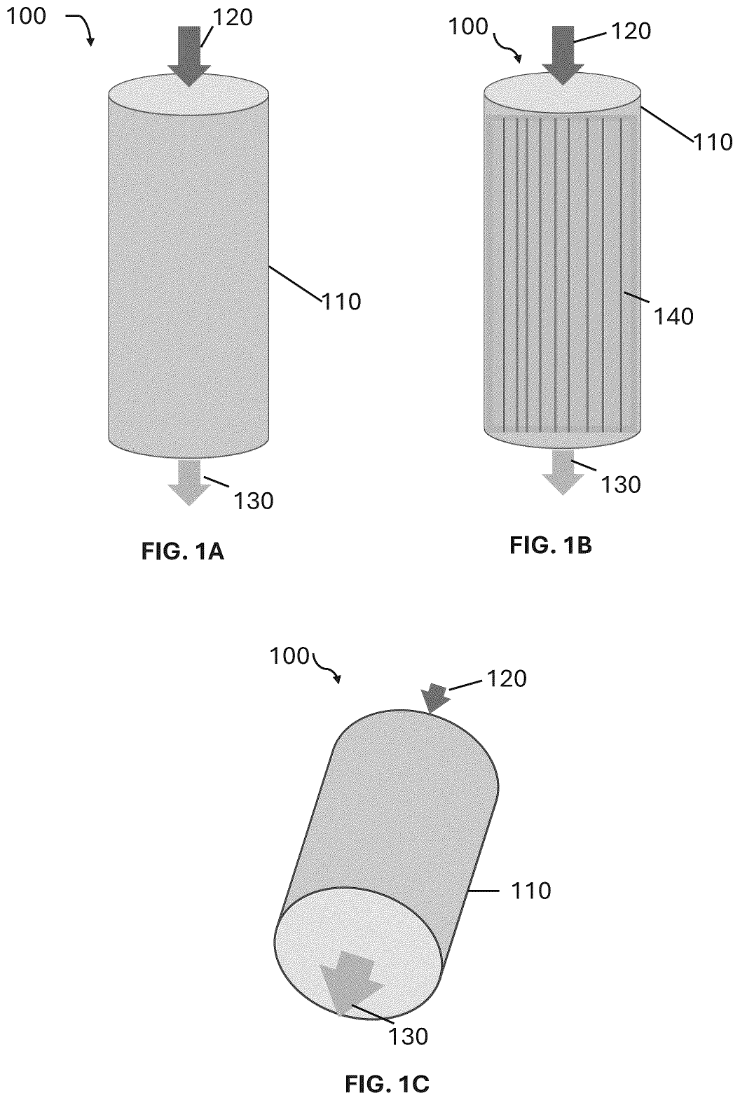

A system in accordance with one or more embodiments of the present disclosure is depicted in FIG. 1A. The system 100 may include an outer housing 110. The outer housing 110 may have an inlet for introducing a solution to be treated for PFAS degradation into a space contained within the outer housing 110. The outer housing 110 may have an outlet for flowing the solution after PFAS degradation out of the outer housing 110. The outer housing 110 may be made from any suitable metal or plastic material that has dimensional stability, heat resistance, and chemical stability so that the shape is retained when exposed to the solution to be treated for PFAS degradation. In one or more embodiments, the outer housing 110 is shaped so that the system 100 fits into current water filtration systems. As such, the outer housing may be an existing piece of a water filtration system. The outer housing may have the dimensions of a length of about 1,177 millimeters (mm) and a diameter ranging from about 172 to about 179 mm. Examples of current water filtrations systems include Microza (AsahiKASEI).

The system 100 may be configured so that an aqueous solution including PFAS may first flow into the space contained within the outer housing 110, as depicted by arrow 120. The system 100 may be then configured so that the aqueous solution including PFAS may come into contact with a porous article 140 including a piezoelectric material enclosed in the outer housing 110, as shown in FIG. 1B. The system 100 may then be configured so that the aqueous solution, now including less PFAS, may flow out of the outer housing, as depicted by arrow 130. The system 100 may be vertically oriented, as shown in FIG. 1A. The system 100 may also be horizontally oriented, as shown in FIG. 1C. The outer housing 110 in FIG. 1C is the same as in FIG. 1A.

The system 100 has a porous article 140 that includes a piezoelectric material. The porous article includes pores. The pores may provide a larger surface area than a non-porous article. The reaction for degrading PFAS is known to be initiated on or near the surface of the piezoelectric material. Thus, the porous article provides an improvement in PFAS degradation since it has a larger surface area. In one or more embodiments, the porous article has a porosity in a range from 40% to 90%. For example, the porous article 140 may have a porosity with a lower limit of one of any 40%, 50%, and 60% with an upper limit of one of any 60%, 70%, 80%, and 90%, where any lower limit may be combined with any mathematically compatible upper limit. Higher porosity may lead to increased PFAS adsorption and solution permeability, which may result in an increased throughput. Lower porosity may result in a reduced throughput; however an increased durability may occur. In one or more embodiments, the porous article 140 including a piezoelectric material has a piezoelectric constant d31 in a range from 5 pC/N to 150 pC/N. For example, the piezoelectric constant may have a lower limit of one of any 5, 15, 25, 40, 65, and 75 pC/N with an upper limit of one of any 80, 95, 110, 125, 140, and 150 pC/N, where any lower limit may be combined with any mathematically compatible upper limit. A higher piezoelectric constant may lead to an increased level of PFAS degradation.

In some embodiments, the porous article may be formed of a polymeric material which comprises a polymer as a matrix. The polymer may be a fluoropolymer, a polyolefin, a polyacrylonitrile, a polysulfone, a polyamide, a polyimide, a polyester, or combinations thereof. In one or more embodiments, the polymer is a fluoropolymer. Fluoropolymers include a carbon-fluoride (C—F) group. The C—F groups are known to interact with each other. In one or more embodiments, PFAS is attracted to the C—F group on the surface of the fluoropolymer.

The fluoropolymer may be a vinylidene fluoride-based (VDF) polymer, a vinyl fluoride-based (VF) polymer, a tetrafluoroethylene-based (TFE) polymer, and combinations thereof. The fluoropolymer may be a homopolymer or a copolymer or any of the aforementioned polymers. Examples of VDF-based polymers may include a VDF-based homopolymer, i.e., polyvinylidene fluoride (PVDF) and VDF-based copolymers, which comonomers of vinylidene fluoride may include trifluoroethylene (TrFE), tetrafluoroethylene (TeFE), hexafluoropropylene (HFP), chlorotrifluoroethylene (CTFE), and combinations thereof. Examples of TFE-polymers may include poly(tetrafluoroethylene) (PTFE), tetrafluoroethylene-perfluoroalkylvinylether copolymer (PFA), tetrafluoroethylene-hexafluoropropylene copolymer (FEP), and ethylene-tetrafluoroethylene copolymer (ETFE).

The porous article may include a cationic functional group on its surface. The cationic functional group may improve the adsorption of PFAS on the porous article. The cationic functional group may be a quaternary ammonium group. The quaternary ammonium group may be included from interactions between the polymer in the porous article and copolymers such as dimethylaminoethyl methacrylate (DMAEMA) to provide the quaternary ammonium. The quaternary ammonium group may be included through methods such as dip-coating or glow dielectric barrier discharge (GDBD) plasma-induced surface grafting the copolymer with the polymer of the porous article. The quaternary ammonium group may be present in the porous article at a concentration ranging from 20 to 30 wt %.

The porous article may include a piezoelectric material. The piezoelectric material provides the porous article with piezoelectricity. Piezoelectricity is a property of generating an electric charge in response to deformation. In one or more embodiments, the piezoelectric material is the fluoropolymer. Examples of fluoropolymers with piezoelectricity include VDF-based polymers. The fluoropolymer of the piezoelectric material may be the VDF-based fluoropolymer as previously described.

The piezoelectric material may be an inorganic piezoelectric material. The inorganic piezoelectric material may be lead zirconate titanate (PZT), BaTiO₃, ZnO, Bi₄Ti₃O₁₂, PbTiO₃, PbNbO₆, SiO₂, and combinations thereof. In one or more embodiments, the inorganic piezoelectric material is embedded into the porous article. The inorganic piezoelectric material may be embedded by any suitable method known in the art for embedding inorganic materials into porous articles. Examples include compounding and spray coating. The inorganic piezoelectric material may be included in the porous article at a concentration equal to or less than 50% v/v (by volume).

The porous article may include a photocatalytic material. The photocatalytic material may generate negatively charged electrons and positively charged hole pairs by absorbing light energy. The negatively charged electrons may be used in an oxidation-reduction reaction to degrade the PFAS. The photocatalytic material may include BiVO₄, BiFeO₃, BiNaTi₂O₆, ZnO nanorods, TiO₂, BiOCl, KNbO₃, NaNbO₃, and combinations thereof. In one or more embodiments, the photocatalytic material is embedded into the porous article. The photocatalytic material may be embedded by any suitable method known in the art for embedding inorganic materials into porous articles. For example, a hybrid membrane of the porous article with the photocatalytic material may be prepared including 18 weight percent (wt %) PVDF and BiVO₄ by dissolving 1.5 grams of PVDF powder in a solution of N-Dimethylformamide (DMF) and acetone at a weight-to-weight ratio of 6:4. The PVDF solution may be mixed for a duration of 5 hours at a temperature of 60° C. The BiVO₄ powder may be added to the PVDF liquid mixture at a concentration of 5 wt %. The resulting new mixture may be sonicated until a uniform dispersion is achieved. Other examples include compounding and spray coating. The photocatalytic material may be included in the porous article at a concentration equal to or less than 20% w/w (by weight).

In some embodiments, the porous article includes a piezoelectric fluoropolymer. The piezoelectric fluoropolymer may be used to generate a piezoelectric effect. In other embodiments, the porous article includes the piezoelectric fluoropolymer and an inorganic piezoelectric material embedded in the piezoelectric fluoropolymer. Both the piezoelectric fluoropolymer and the inorganic piezoelectric material may be used to generate the piezoelectric effect. In other embodiments, the porous article includes a fluoropolymer that is not piezoelectric and an inorganic piezoelectric material embedded in the fluoropolymer. The inorganic piezoelectric material may be used to generate the piezoelectric effect. In other embodiments, the porous article includes a photocatalytic material. The porous article including the photocatalytic material may include a piezoelectric fluoropolymer or an inorganic piezoelectric material. The piezoelectric material may increase the generation of pairs of electrons and holes in the photocatalytic material.

The shape of the porous article may increase the piezoelectric effect of the porous article. For example, certain shapes of the article may provide higher available surface area which may, in turn, increase the piezoelectric effect. The higher the surface area of the porous article, the larger the piezoelectric effect may be. However, a higher surface area may reduce the strength of the porous article. In one or more embodiments, the system includes a plurality of the porous articles being arranged in the outer housing. Each of the plurality of porous articles may have a certain shape optimized for arrangement in the outer housing. The shape of the porous article may be optimized to maximize the surface area for PFAS degradation. The porous article may be a fiber, a bead, a film, a sponge, or combinations thereof.

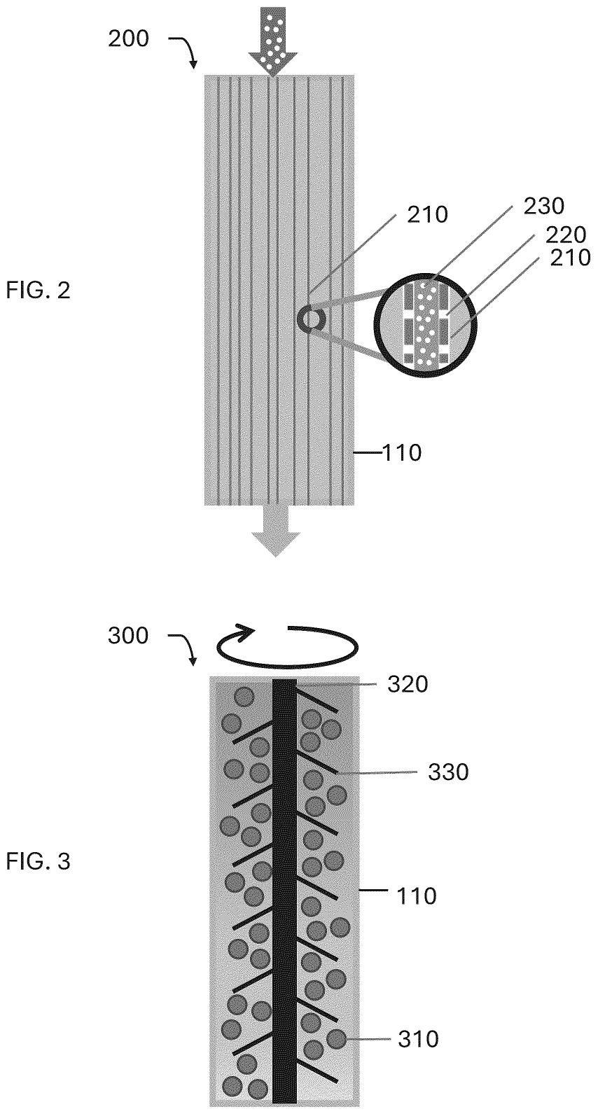

FIG. 2 depicts a system 200 including a porous article that is a piezoelectric fiber 210 inside an outer housing 110, according to one or more embodiments. As shown by the expanded view shown in the circle in FIG. 2, the piezoelectric fiber 210 is hollow. The piezoelectric fiber also includes pores 220. The pores 220 allow for bubbles 230 present in the aqueous solution including PFAS to pass from inside the hollow fiber to outside the hollow fiber, where cavitation may be used to produce a piezoelectric effect from the piezoelectric fiber 210. The piezoelectric fiber 210 may have the dimensions of an outer diameter and an inner diameter. The outer diameter may range from 0.90 to 1.66 millimeters (mm), The inner diameter may range from 0.41 to 1.13 mm. The pores 220 may have an average pore diameter of 0.065 to 0.129 microns in diameter.

The hollow fiber made be made by melt-extrusion. A plasticizer may be added to create the pores in the hollow fiber. The plasticizer may be any plasticizer suitable for use with the porous article. Examples may include aliphatic polyesters of a dibasic acid and a glycol. The hollow fiber may be extruded at a temperature ranging from 140 to 270° C. Any extruder suitable for making a hollow fiber may be used. An example extruder may include a twin-screw kneading extruder. After extrusion, the hollow fiber may be cooled with a cooling liquid. Any liquid that is non-reactive and does not dissolve the porous article may be used. The hollow fiber may be cooled at a temperature ranging from 5 to 120° C. After cooling, the hollow fiber may be heat treated to improve the degree of crystallization. Heat treatment may occur at a temperature ranging from 80 to 160° C.

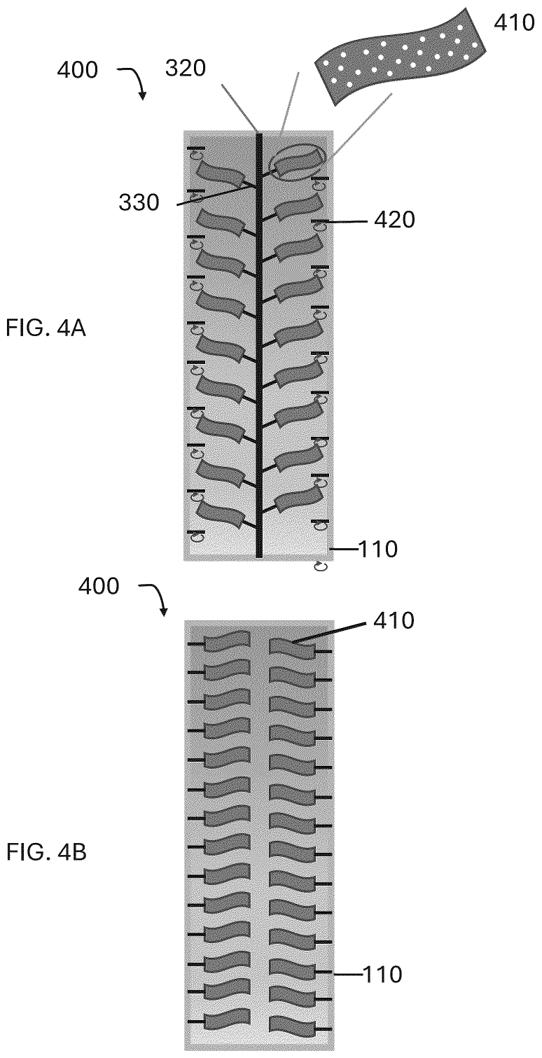

FIG. 3 depicts a system 300 including a screw and a porous article shaped as a piezoelectric bead 310 inside an outer housing 110, according to one or more embodiments. The screw may include a screw shaft 320 and screw threads 330. The screw may be made of any suitable material with dimensional stability, heat resistance, and chemical stability when degrading PFAS.

The screw may be configured to agitate the piezoelectric beads 310 to produce a piezoelectric effect. The piezoelectric beads may be made by dissolving a polymer for the porous article in a first solvent. The first solvent may be any solvent suitable for dissolving the polymer for the porous article at an elevated temperature to form a polymer solution. The elevated temperature may range from 110 to 140° C. After dissolving, the polymer solution may be dispersed with mechanical stirring in an immiscible liquid, for example, mineral oil. The polymer solution may also be dispersed by homogenization or ultrasonification. Phase separation will occur with the polymer solution and the immiscible liquid, leading to the formation of droplets. The droplets may be extracted and dried to produce the piezoelectric beads 310. The piezoelectric beads 310 may have an average diameter ranging from 20 to 400 microns. The piezoelectric beads 310 may have pores. The pores may have an average diameter ranging from 0.002 to 5 microns.

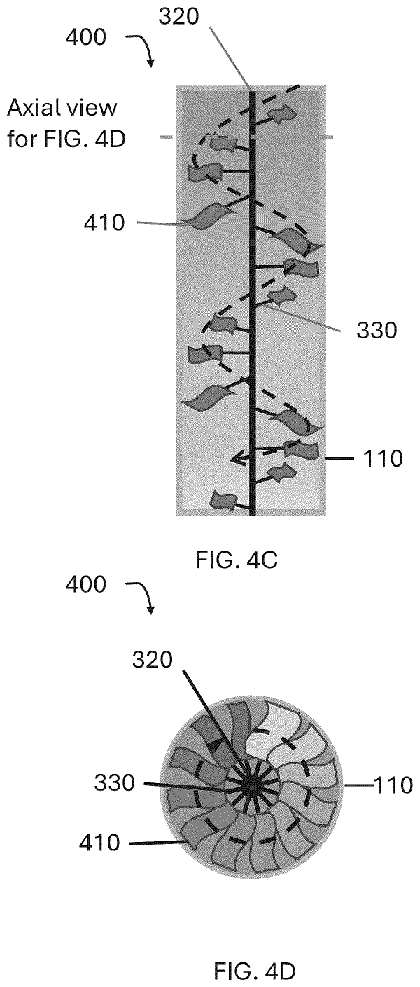

FIG. 4A depicts a system 400 including a screw and a porous article shaped as a piezoelectric film 410 inside an outer housing 110, according to one or more embodiments. The screw may include a screw shaft 320 and screw threads 330. The screw is as previously described in FIG. 3. In the system 400, the screw shaft 320 is fixed. The screw threads 330 may have the piezoelectric film 410 attached to an outer end of the screw thread 330. The piezoelectric film 410 may be attached on one length of the film to the screw thread 330 by adhesive. Any known adhesive suitable for adhering materials in aqueous conditions may be used. In one or more embodiments, the screw threads 330 may include hooks. The piezoelectric film 410 may include holes. The holes of the piezoelectric film 410 may be aligned with the hooks of the screw thread 330 to produce attachment. In other embodiments, the screw shaft 320, the screw threads 330, and the piezoelectric film 410 are made from a mold such that they are integral to each other.

In one or more embodiments, the piezoelectric film 410 includes non-woven microfibers of a porous article. The microfibers may be spun by electric field spinning. The spun microfibers may be formed into a film shape.

In one or more embodiments, the piezoelectric film 410 is formed from casting. Casting may include dissolving a porous article in a solvent (i.e., acetone) to produce a polymer solution. The polymer solution may be cast onto a glass plate. The glass plate may then be placed in a water bath to remove the polymer from the plate. A porous film of the polymer may be produced. The porous film may then be sandwiched between PVDF and uniaxially stretched. After stretching, the porous film may undergo poling. After poling, the porous film may be cut into strips and woven into a fabric. The fabric may then be formed into a film shape

The system 400 may include baffles 420. The baffles 420 may be configured to block the lamellar flow of water through the system 400 and generate turbulent flow. The turbulent flow may be used to produce a piezoelectric effect from the piezoelectric film 410.

FIG. 4B depicts a system 400 including a porous article shaped as a piezoelectric film 410 inside an outer housing 110, according to one or more embodiments. The piezoelectric film 410 may be attached to an inner wall of the outer housing 110. The piezoelectric film 410 may be attached on one length of the film to the inner wall by adhesive. Any known adhesive suitable for adhering materials in aqueous conditions may be used. In one or more embodiments, the inner wall of the outer housing 110 may include hooks. The piezoelectric film 410 may include holes. The holes of the piezoelectric film 410 may be aligned with the hooks of the inner wall to produce attachment. The attachment of the piezoelectric film 410 to the inner wall may block the lamellar flow of water inside the system, thus generating turbulent flow. Turbulent flow through the system 400 may be used to produce a piezoelectric effect from the piezoelectric film 410.

FIG. 4C depicts a system 400 including a screw and a porous article shaped as a piezoelectric film 410 inside an outer housing 110, according to one or more embodiments. The piezoelectric film 410 is attached to a screw shaft 320 and screw threads 330 in a spiral arrangement. FIG. 4D depicts an axial view of FIG. 4C at the indicated line. Rotation of the piezoelectric film 410 attached to the screw in a spiral arrangement (as shown by the arrow in FIG. 4D) produces a vortex. The vortex may produce a piezoelectric effect from the piezoelectric film 410.

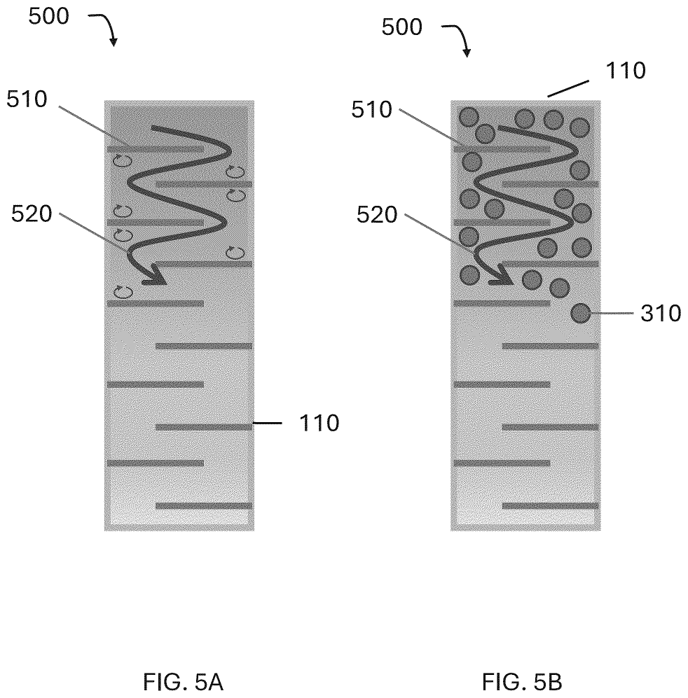

FIG. 5A depicts a system 500 including a porous article shaped as a piezoelectric sponge 510 inside an outer housing 110, according to one or more embodiments. The piezoelectric sponge 510 is attached to an inner wall of the outer housing 110. The piezoelectric sponge 510 is spaced evenly on the inner wall in order to block the lamellar flow of water and generate turbulent flow. As indicated by arrow 520, the water may flow through the system 500 and the flow may be blocked by the piezoelectric sponge 510. The blocking may produce the turbulent flow. The turbulent flow may deform the piezoelectric sponge 510 and produce a piezoelectric effect. The piezoelectric sponge 510 may include a core. The core may be perforated to allow water to flow through. The porous article may be attached to the core to produce the piezoelectric sponge 510.

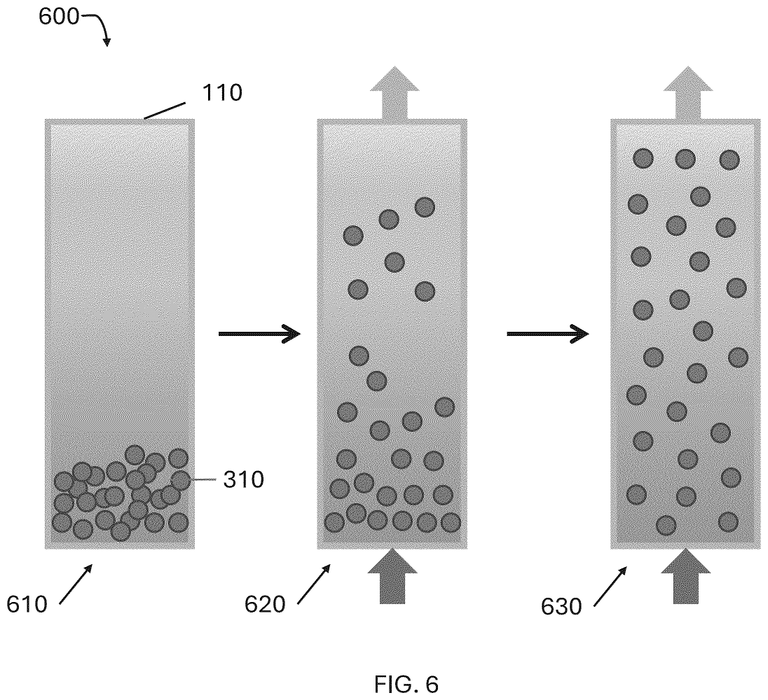

FIG. 5B depicts a system 500 including a porous article shaped as a piezoelectric sponge 510 and a porous article shaped as a piezoelectric bead 310 inside an outer housing 110, according to one or more embodiments. The piezoelectric sponge 510 is attached to an inner wall of the outer housing 110. The piezoelectric sponge 510 is spaced evenly on the inner wall in order to block lamellar flow of water and generate turbulent flow. As indicated by arrow 520, the water may flow through the system 500 and the flow may be blocked by the piezoelectric sponge 510. The blocking may produce the turbulent flow. The turbulent flow may deform the piezoelectric sponge 510 and the piezoelectric beads 310 and produce a piezoelectric effect. The piezoelectric beads may move randomly within the outer housing 110. FIG. 6 depicts a system 600 including a porous article shaped as a piezoelectric bead 310 inside an outer housing 110, according to one or more embodiments. In an initial state 610, the system 600 may include the piezoelectric beads 310 at one end of the outer housing 110. When water begins to flow through the system as indicated by 620, the piezoelectric beads 310 may begin to move inside the outer housing 110. The piezoelectric beads 310 may reach a steady state dispersed within the outer housing 110 as indicated by 630. The flow of water through the outer housing 110 may produce the turbulent flow. The turbulent flow may deform the piezoelectric beads 310 and produce a piezoelectric effect.

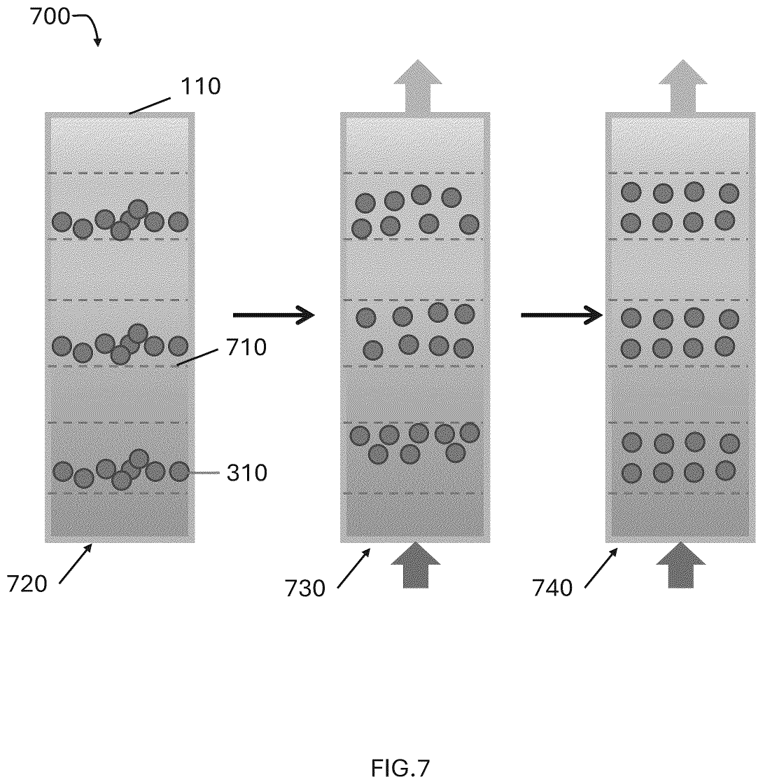

FIG. 7 depicts a system 700 including a porous article shaped as a piezoelectric bead 310 inside an outer housing 110, according to one or more embodiments. The piezoelectric beads 310 may be arranged in a fluidized bed 710. The fluidized bed may be made of a metal alloy. Example suitable metal alloys may include Inconel and Hastelloy, among others. A plurality of fluidized beds 710 may result in a multi-stage system for PFAS degradation. In an initial state 720, the system 700 may include the piezoelectric beads 310 arranged in the fluidized bed 710. When water begins to flow through the system as indicated by 730, the piezoelectric beads 310 may begin to move inside the fluidized bed 710. The piezoelectric beads 310 may reach a steady state dispersed within the fluidized bed 710 as indicated by 740. The flow of water through the fluidized bed 710 may produce the turbulent flow. The turbulent flow may deform the piezoelectric beads 310 and produce a piezoelectric effect.

In one or more embodiments, the porous article is woven. Woven articles may have an increased strength and ability to maintain their shape during PFAS degradation. The increased strength may lead to a sustained ability to generate the piezoelectric effect. In other embodiments, the porous article is non-woven. Non-woven articles may be easier to control the porosity which may lead to an increased surface area. The increased surface area may lead to an increased piezoelectric effect.

A system for PFAS degradation includes a piezoelectric effect initiator. The piezoelectric effect initiator may be anything that initiates a piezoelectric effect from a porous article that includes a piezoelectric material. In one or more embodiments, the piezoelectric effect initiator is a sonicator. The sonicator may produce ultrasonic frequencies. The ultrasonic frequencies may produce bubbles when in contact with water. The ultrasonic frequencies produced may range from 20 kilohertz (kHz) to 1,000 kHz. The bubbles may be produced in an aqueous solution including PFAS before contacting the system 100. The aqueous solution including PFAS and including the bubbles may contact the porous article including the piezoelectric material. The bubbles may burst on contact, and the resulting cavitation may generate a piezoelectric effect.

The piezoelectric effect initiator may be a power source that can apply a voltage. Examples of the power source may include any source suitable for producing a pulse voltage. The frequency of the pulse voltage may range from 1 Hz to 5 kHz. The voltage may range from 1 millivolt (mV) to 10 V. The power source may provide a voltage to the porous article including a piezoelectric material. The voltage may generate a piezoelectric effect.

The piezoelectric effect initiator may be any device that is suitable for generating turbulence. For example, the piezoelectric effect initiator may be an inline static mixer. The inline static mixer may produce turbulent flow within the system 100. A speed equal to at least 0.2 meters per second (m/s) may be required to produce turbulent flow. Turbulent flow from the inline static mixer may deform the porous article including a piezoelectric material. The deformation may generate a piezoelectric effect.

A system for PFAS degradation may further include a component that may enhance the PFAS degradation. For example, the system may include a UV-visible irradiation source. The UV-visible irradiation source may promote PFAS degradation. The UV-visible irradiation source may emit wavelengths of about 254 nanometers. Examples of the UV-visible irradiation source may include an 18 W low pressure mercury lamp. The UV-visible irradiation source may be placed on the inner wall of the outer housing in a position so that the UV-visible irradiation is uniformly irradiated within the outer housing. For example, the UV-visible irradiation source may be placed along the central axis of the outer housing.

A system for PFAS degradation may include a plasma torch. The plasma torch may produce ions which may promote PFAS degradation. The ions may have an energy ranging from 0.24 to 0.63 Joules per pulse. Pulses may have a frequency of about 40 Hz.

A system for PFAS degradation may include a heat source and a vacuum pump. The heat source and the vacuum pump in contact with the aqueous solution including PFAS may produce subcritical or supercritical water. Subcritical and supercritical water may oxidize PFAS and promote PFAS degradation. Subcritical water occurs at a temperature of at least 374° C. and a pressure of at least 22.1 MPa. Supercritical water occurs at a temperature of at least 550° C. and a pressure of about 23 MPa. The heat source may be a tube-in-tube heat exchanger. The vacuum pump may be a back pressure regulator.

In one or more embodiments, the subcritical or supercritical water is generated inside an outer housing. A lining may be required inside the outer housing. The lining may be able to withstand the pressure and temperature requirements of generating subcritical and supercritical water. A porous article including a piezoelectric material may be a heat-resistant polymer. Examples of suitable heat-resistant polymers include polyimide, PTFE, ETFE, and combinations thereof. In some embodiments, the porous article including a piezoelectric material is PVDF. If the porous article includes PVDF, the subcritical or supercritical water may be generated outside the outer housing.

### Method for PFAS Degradation

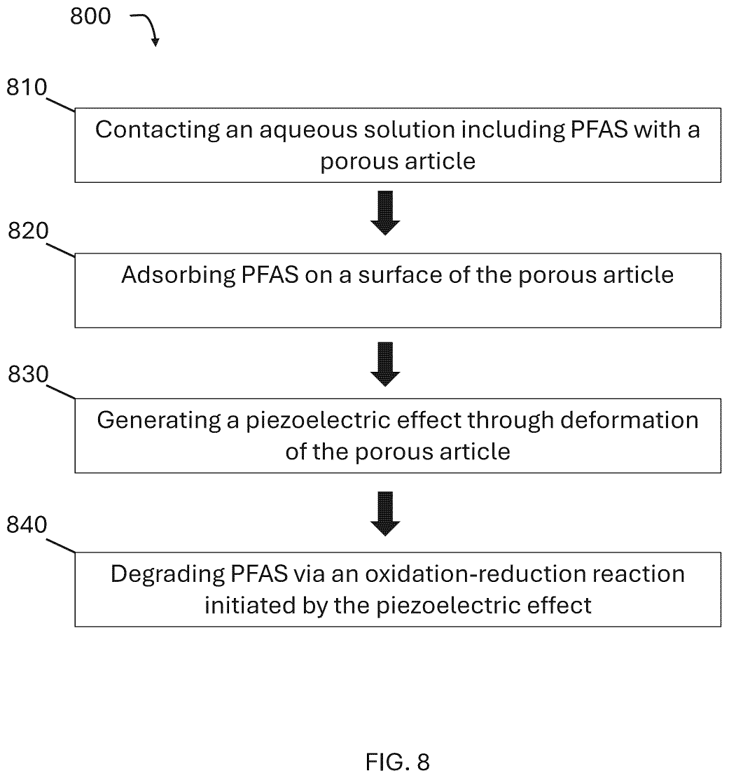

Embodiments disclosed herein are related to a method for PFAS degradation. The method 800 is shown in a flowchart in FIG. 8. The method 800 includes, at block 810, contacting an aqueous solution including PFAS with a porous article. The porous article may have a porosity in a range from 40% to 90%. The porous article may have a piezoelectric constant d31 in a range from 5 pC/N to 150 pC/N. The porous article is as described above.

The aqueous solution may include PFAS at a concentration ranging from 10 parts per trillion (ppt) to 600 parts per billion (ppb). Contact may occur by flowing the aqueous solution including PFAS into an outer housing that includes the porous article. A flow rate of the aqueous solution may be equal to or less than 8 feet per second (ft/s). The flow of the aqueous solution including PFAS may be continuous or intermittent. The amount of time that the water is in contact with the system is dependent on the flow rate and whether the flow is continuous or intermittent. As will be appreciated by those skilled in the art, water may be treated multiple times to achieve a desired level of PFAS in the water.

The method 800 may include, at block 820, adsorbing the PFAS onto a surface of the porous article. Adsorption may occur through an electrostatic interaction between the fluoropolymer with cationic functional groups and PFAS species. The electrostatic interactions include cation/anion interactions and van der Waals interactions. The adsorption may be improved by including a cationic functional group on the surface of the porous article. The cationic functional group is as previously described. An electrostatic interaction between the cationic functional group and PFAS may result in a better adsorption of PFAS onto the surface of the porous article. After adsorption, the PFAS may decompose into fluoride ions and carbon dioxide molecules. Decomposition may occur by an oxidation-reduction reaction. The fluoride ions and carbon dioxide molecules may be released from the surface of the porous article into the aqueous solution.

The method 800 may include, at block 830, generating a piezoelectric effect through deformation of the porous article. Piezoelectric effects are produced by deformation of piezoelectric materials, where the deformation produces an electric charge. In one or more embodiments, deformation may occur by cavitation, turbulent flow, or voltage. Deformation by cavitation, turbulent flow, or voltage may depend on the shape of the porous article.

Generating the piezoelectric effect may include creating cavitation. Cavitation may occur when bubbles in the aqueous solution including PFAS are ruptured by contact with the porous articles. The bubbles may be produced in the aqueous solution including PFAS prior to contacting the porous article. The bubbles may be produced by exposing the aqueous solution to a sonicator. The sonicator is as previously described for the system. Once bubbles are formed and they contact the porous article, cavitation may occur when the bubbles burst to generate the piezoelectric effect.

Generating the piezoelectric effect may include creating turbulent flow. Turbulent flow may occur by agitating the aqueous solution including PFAS inside the outer housing. Agitating may occur using an inline static mixer. The inline static mixer is as previously described. Agitating may further occur using a screw. The screw is as previously described. In one or more embodiments, agitating the aqueous solution including PFAS inside the outer housing with the screw creates a vortex, where the vortex creates turbulent flow.

Agitating may also include blocking the flow of water through portions of the system to create turbulent flow. Blocking the flow of water may be done by the porous article. In one or more embodiments, porous articles shaped as beads, film, and sponges block the laminar flow of water in the system, thus creating turbulent flow. Blocking the flow of water may also be done by baffles. The baffles are as previously described for the system. The baffles may block the laminar flow of water through the system, thus creating turbulent flow. Turbulent flow may deform the porous article, thus generating the piezoelectric effect.

Generating the piezoelectric effect may include applying voltage. Voltage may be applied to the porous article by a power source. The power source is as previously described for the system. The charge produced from applying the voltage may deform the porous article, thus generating the piezoelectric effect.

The method 800 may include, as in block 840, degrading PFAS via an oxidation-reduction reaction initiated by a piezoelectric effect. Piezoelectric effects are produced by deformation of piezoelectric materials. The deformation displaces the atoms in the piezoelectric material (i.e., porous article), generating a dipole moment. Multiple dipole moments may be generated throughout the piezoelectric material (i.e., porous article), generating the piezoelectric effect. The piezoelectric effect is known to produce an electric charge. The electric charge may be used to break the C—F bond in PFAS, thus degrading PFAS. In one or more embodiments, the method 800 degrades PFAS in the aqueous solution by an amount at least 5% of the original concentration. The amount of degradation may depend on the porous article, the flow rate of the aqueous solution including PFAS, the original concentration of PFAS, and the type of PFAS.

The method 800 may also include degrading PFAS through other methods in addition to the oxidation-reduction reaction initiated by the piezoelectric effect. The other methods may include UV-visible irradiation, ultrasonic irradiation, plasma irradiation, or subcritical or supercritical water treatment. In one or more particular embodiments, the other method is ultrasonic irradiation. The other methods may occur simultaneously with block 840 of method 800. For example, degrading PFAS may occur simultaneously by the oxidation-reduction reaction and UV-visible irradiation. The combination of the other methods and the oxidation-reduction reaction may produce an increased amount of degradation than the redox reaction alone.

Degrading PFAS may occur simultaneously by UV-visible irradiation. UV-visible irradiation is produced by a UV-visible irradiation source. The UV-visible irradiation source is as previously described for the system. UV-visible irradiation may occur continuously. The aqueous solution including PFAS may require a residence time in the system under UV-visible irradiation for degradation of PFAS to occur. The residence time may be less than with the piezoelectric effect alone. Ions may be added to accelerate the degradation. Ions may include iodide ions and sulfite ions. The iodide ions may be from any water soluble iodide salt, such as potassium iodide, The sulfite ions may be from any water soluble sulfite salt, such as sodium sulfite. The UV-visible irradiation may break the C—F bond in PFAS, thus degrading the PFAS.

Degrading PFAS may occur simultaneously by ultrasonic irradiation. Ultrasonic irradiation is produced by a sonicator. The sonicator is the same as previously described. Ultrasonic irradiation may occur continuously. The aqueous solution including PFAS may require a residence time in the system under ultrasonic irradiation for degradation of PFAS to occur. The residence time may be less than with the piezoelectric effect alone. The ultrasonic irradiation may produce ultrasonic waves. The ultrasonic waves may break the C—F bond in PFAS, thus degrading the PFAS.

Degrading PFAS may occur simultaneously by plasma irradiation. Plasma irradiation is produced by a plasma torch. The plasma torch is as previously described for the system. Plasma irradiation may occur continuously. The aqueous solution including PFAS may require a residence time in the system under plasma irradiation for degradation of PFAS to occur. The residence time may be less than with the piezoelectric effect alone. The plasma irradiation may provide ions. The ions may break the C—F bond in PFAS, thus degrading the PFAS.

Degrading PFAS may occur simultaneously with subcritical or supercritical water treatment. Subcritical water occurs at a temperature of at least 374° C. and a pressure of at least 22.1 MPa. Supercritical water occurs at a temperature of at least 550° C. and a pressure of about 23 MPa. The subcritical and subcritical water may be produced with a heat source and a vacuum pump. The heat source and vacuum pump are as previously described. The residence time may be less than with the piezoelectric effect alone. The subcritical or supercritical water may oxidize the C—F bond in PFAS, thus degrading the PFAS.

Embodiments of the present disclosure may provide at least one of the following advantages. The system and method as described herein may produce a more efficient surface reaction than methods known in the art. The improved efficiency may be due to the increased surface area of the porous article. The system and method as described herein may exhibit an improved PFAS selectivity over methods known in the art. The improved selectivity may be due to the increased adsorption of PFAS on the porous article. The increased adsorption may be due to the cationic functional group included in the porous article. The porous article may capture a series of PFAS regardless of the length of the carbon chain due to the effect of various electrostatic interactions. The system as described herein is easy to install in existing water treatment systems.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for per- and poly-fluoroalkyl substance degradation comprising:
an outer housing; and
a porous article comprising a piezoelectric material;
wherein the porous article has a porosity in a range from 40% to 90% and a piezoelectric constant d31 in a range from 5 pC/N to 150 pC/N.

2. The system of claim 1, wherein the piezoelectric material is a fluoropolymer.

3. The system of claim 2, wherein the fluoropolymer is selected from the group consisting of a vinylidene fluoride-based polymer, a vinyl fluoride-based polymer, a tetrafluoroethylene-based polymer, and combinations thereof.

4. The system of claim 3, wherein the fluoropolymer is polyvinylidene fluoride, polyvinyl fluoride, poly(tetrafluoroethylene), perfluoroalkoxy, tetrafluoroethylene-hexafluoropropylene copolymer, or ethylene-tetrafluoroethylene copolymer.

5. The system of claim 1, wherein the porous article comprises a cationic functional group.

6. The system of claim 5 wherein the cationic functional group is a quaternary ammonium group.

7. The system of claim 2, wherein the piezoelectric material comprises an inorganic piezoelectric material.

8. The system of claim 7, wherein the piezoelectric material is selected from the group consisting of lead zirconate titanate, BaTiO₃, ZnO, Bi₄Ti₃O₁₂, PbTiO₃, PbNbO₆, SiO₂, and combinations thereof.

9. The system of claim 1, wherein the porous article further comprises a photocatalytic material.

10. The system of claim 9, wherein the photocatalytic material is selected from the group consisting of BiVO₄, BiFeO₃, BiNaTi₂O₆, ZnO nanorods, TiO₂, BiOCl, KNbO₃, NaNbO₃, and combinations thereof.

11. The system of claim 1, wherein the porous article is in a form selected from the group consisting of a fiber, a bead, a film, a sponge, and combinations thereof.

12. The system of claim 11, wherein the fiber is hollow.

13. The system of claim 1, wherein the porous article is woven.

14. The system of claim 1, wherein the porous article is non-woven.

15. The system of claim 1, wherein the system further comprises a piezoelectric effect initiator.

16. The system of claim 15, wherein the piezoelectric effect initiator is selected from the group consisting of a sonicator, a power source, an inline static mixer, and combinations thereof.

17. The system of claim 1, further comprising a component selected from the group consisting of a UV-visible irradiation source, a plasma torch, a heat source, a vacuum pump, and combinations thereof.

18. A method for per- and poly-fluoroalkyl substance degradation comprising:
contacting an aqueous solution comprising per- and poly-fluoroalkyl substances with a porous article, wherein the porous article has a porosity in a range from 40% to 90% and a piezoelectric constant d31 in a range from 5 pC/N to 150 pC/N;
adsorbing the per- and poly-fluoroalkyl substances on a surface of the porous article;
generating a piezoelectric effect through deformation of the porous article; and
degrading the per- and poly-fluoroalkyl substances via an oxidation-reduction reaction initiated by the piezoelectric effect.

19. The method of claim 18, wherein adsorbing the per- and poly-fluoroalkyl substances on the surface of the porous article comprises an electrostatic interaction between cationic functional groups on the porous article and the per- and poly-fluoroalkyl substances.

20. The method of claim 18, wherein generating the piezoelectric effect comprises creating cavitation, creating turbulent flow, or applying a voltage.

21. The method of claim 18, wherein the method further comprises further degrading the per- and poly-fluoroalkyl substances via UV-visible irradiation, ultrasonic irradiation, plasma irradiation, or subcritical or supercritical water treatment.
